(19) United States
(12) Patent Application Publication
(10) Pub. No.: US 2024/0373128 A1
(43) Pub. Date: Nov. 7, 2024

(54) IMAGE CORRECTION BASED ON ACTIVITY DETECTION

(71) Applicant: QUALCOMM Incorporated, San Diego, CA (US)

(72) Inventors: Eliad Tsairi, Hof HaCarmel (IL); Ron Gaizman, Hof HaCarmel (IL); Yu-Chen Hsu, Beitou Dist (TW); Xiongfei Yu, Shenzhen (CN)

(21) Appl. No.: 18/724,917

(22) PCT Filed: Dec. 31, 2021
(86) PCT No.: PCT/CN2021/143724

§ 371 Date: Jun. 27, 2024

(51) Int. Cl. H04N 23/68; H04N 23/611

(52) U.S. Cl. CPC H04N 23/683; H04N 23/611; H04N 23/6812

(57) ABSTRACT

The present disclosure provides systems, apparatus, methods, and computer-readable media that support adapting image processing based on the user activity performed while recording an image. In a first aspect, a method of image processing may include determining a type of activity based on sensor data, such as motion sensors and/or image sensor data. The type of activity may be provided to an image processing algorithm, such as an image/video stabilization algorithm, which adapts based on the activity type. For example, a rolling shutter correction may have a strength factor that is adapted to lower values when the type of activity is a panning motion when faces are present in the frame. As another example, another image stabilization (IS) algorithm such as an electronic image stabilization (EIS) algorithm may have adaptive behavior adjusted based on the type of activity. Other aspects and features are also claimed and described.

### TECHNICAL FIELD

Aspects of the present disclosure relate generally to image processing, and more particularly, to adjusting image correction processing based on user activity. Some features may alter behavior and provide improved image processing, including image stabilization.

### INTRODUCTION

Image capture devices are devices that can capture one or more digital images, whether still image for photos or sequences of images for videos. Capture devices can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

Movement of an image capture device during recording of a photograph or video can blur and otherwise distort the image captured by the image capture device. Specifically, global motion caused by, e.g., a user's hand causing device jitter, translational or rotational movement of the device, etc., may cause blurring in an image or video. Blurring of objects in the scene (or of the entire scene) may reduce the image quality. Other issues that may result from movement during recording are geometric distortions of the objects, distortions such as rolling shutter distortion, lens distortion, and z-lens positions FOV effects.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In some aspects, an activity performed by a user while recording photographs and/or videos may be determined and the processing of image data to generate the photographs and/or videos adapted based on the user activity. Example classification of activities include whether activities are indoor or outdoor, stationary or moving, or walking or running. The processing of the image data to generate a photograph and/or video may be adapted based on the classification of the user activity, such as by adapting a rolling shutter correction and/or adapting other image stabilization operations based on the user activity.

In one aspect of the disclosure, a method for image processing includes receiving first image data; receiving a first activity indication; and generating an image frame based on the first image data and based on the first activity indication by applying image stabilization to the first image data based on the first activity indication. For example, the first activity indication may be used to determine a first type of activity from a plurality of activity types; and the image frame may be generated based on the first image data and based on the first type of activity by applying image stabilization to the first image data based on the first type of activity.

In an additional aspect of the disclosure, an apparatus, such as an image capture device, includes at least one processor and a memory coupled to the at least one processor. The at least one processor is configured to perform operations including receiving first image data; receiving a first activity indication; determining a first type of activity from a plurality of activity types based on the first activity indication; and/or generating an image frame based on the first image data and based on the first type of activity by applying image stabilization to the first image data based on the first type of activity.

In an additional aspect of the disclosure, an apparatus includes means for receiving first image data; means for receiving a first activity indication; means for determining a first type of activity from a plurality of activity types based on the first activity indication; and/or means for generating an image frame based on the first image data and based on the first type of activity by applying image stabilization to the first image data based on the first type of activity.

In an additional aspect of the disclosure, a non-transitory computer-readable medium stores instructions that, when executed by a processor, cause the processor to perform operations. The operations include receiving first image data; receiving a first activity indication; determining a first type of activity from a plurality of activity types based on the first activity indication; and/or generating an image frame based on the first image data and based on the first type of activity by applying image stabilization to the first image data based on the first type of activity.

Image capture devices, devices that can capture one or more digital images whether still image photos or sequences of images for videos, can be incorporated into a wide variety of devices. By way of example, image capture devices may comprise stand-alone digital cameras or digital video camcorders, camera-equipped wireless communication device handsets, such as mobile telephones, cellular or satellite radio telephones, personal digital assistants (PDAs), panels or tablets, gaming devices, computer devices such as webcams, video surveillance cameras, or other devices with digital imaging or video capabilities.

In general, this disclosure describes image processing techniques involving digital cameras having image sensors and image signal processors (ISPs). The ISP may be configured to control the capture of image frames from one or more image sensors and process one or more image frames from the one or more image sensors to generate a view of a scene in a corrected image frame. A corrected image frame may be part of a sequence of image frames forming a video sequence. The video sequence may include other image frames received from the image sensor or other images sensors and/or other corrected image frames based on input from the image sensor or another image sensor. In some embodiments, the processing of one or more image frames may be performed within the image sensor. The image processing techniques described in embodiments disclosed herein may be performed by circuitry in the image sensor, in the image signal processor (ISP), in the application processor (AP), or a combination or two or all of these components.

In an example, the image signal processor may receive an instruction to capture a sequence of image frames in response to the loading of software, such as a camera application, to produce a preview display from the image capture device. The image signal processor may be configured to produce a single flow of output frames, based on images frames received from one or more image sensors. The single flow of output frames may include raw image data from an image sensor or corrected image frames processed by one or more algorithms within the image signal processor. For example, an image frame obtained from an image sensor, which may have performed some processing on the data before output to the image signal processor may be processed in the image signal processor by processing the image frame through an image post-processing engine (IPE) and/or other image processing circuitry for performing one or more of tone mapping, portrait lighting, contrast enhancement, gamma correction, etc. In some embodiments, data flow may proceed from an image sensor to an IFE to an EIS to an IPE. In some embodiments, data flow may proceed from an image sensor to an IFE to an IPE to an EIS

After an output frame representing the scene is determined by the image signal processor using the image correction described in various embodiments herein, the output frame may be displayed on a device display as a single still image and/or as part of a video sequence, saved to a storage device as a picture or a video sequence, transmitted over a network, and/or printed to an output medium. For example, the image signal processor may be configured to obtain input frames of image data (e.g., pixel values) from the different image sensors, and in turn, produce corresponding output frames of image data (e.g., preview display frames, still-image captures, frames for video, etc.). In other examples, the image signal processor may output frames of the image data to various output devices and/or camera modules for further processing, such as for 3A parameter synchronization (e.g., automatic focus (AF), automatic white balance (AWB), and automatic exposure control (AEC)), producing a video file via the output frames, configuring frames for display, configuring frames for storage, transmitting the frames through a network connection, etc. That is, the image signal processor may obtain incoming frames from one or more image sensors, each coupled to one or more camera lenses, and, in turn, may produce and output a flow of output frames to various output destinations. In such examples, the image signal processor may be configured to produce a flow of output frames that may have improved appearance in low-light conditions.

In some aspects, the corrected image frame may be produced by combining aspects of the image correction of this disclosure with other computational photography techniques such as high dynamic range (HDR) photography or multi-frame noise reduction (MFNR). With HDR photography, the first image frame and a second image frame (and possibly additional image frames) are captured using different exposure times, different apertures, different lenses, and/or different other characteristics that may result in improved dynamic range of a fused image when the two image frames are combined. In some aspects, the method may be performed for MFNR photography in which the first image frame and a second image frame are captured using the same or different exposure times and fused to generate a corrected first image frame with reduced noise compared to the captured first image frame.

In some aspects, a device may include an image signal processor or a processor (e.g., an application processor) including specific functionality for camera controls and/or processing, such as enabling or disabling the image correction or otherwise controlling aspects of the image correction, such as by controlling an image stabilization algorithm, controlling a distortion correction algorithm, determining when to apply deblurring, applying a deblurring operation to a blurry object, controlling a zoom level of a resulting image, enabling or disabling or controlling the distortion correction of the image, and/or altering video stabilization behaviors. The methods and techniques described herein may be entirely performed by the image signal processor or a processor, or various operations may be split between the image signal processor and a processor, and in some aspects split across additional processors.

The apparatus may include one, two, or more image sensors, such as including a first image sensor. When multiple image sensors are present, the first image sensor may have a larger field of view (FOV) than the second image sensor or the first image sensor may have different sensitivity or different dynamic range than the second image sensor. In one example, the first image sensor may be a wide-angle image sensor, and the second image sensor may be a tele image sensor. In another example, the first sensor is configured to obtain an image through a first lens with a first optical axis and the second sensor is configured to obtain an image through a second lens with a second optical axis different from the first optical axis. Additionally or alternatively, the first lens may have a first magnification, and the second lens may have a second magnification different from the first magnification. This configuration may occur with a lens cluster on a mobile device, such as where multiple image sensors and associated lenses are located in offset locations on a frontside or a backside of the mobile device. Additional image sensors may be included with larger, smaller, or same field of views. The image correction techniques described herein may be applied to image frames captured from any of the image sensors in a multi-sensor device.

In an additional aspect of the disclosure, a device configured for image processing and/or image capture is disclosed. The apparatus includes means for capturing image frames. The apparatus further includes one or more means for capturing data representative of a scene, such as image sensors (including charge-coupled devices (CCDs), Bayer-filter sensors, infrared (IR) detectors, ultraviolet (UV) detectors, complimentary metal-oxide-semiconductor (CMOS) sensors), time of flight detectors. The apparatus may further include one or more means for accumulating and/or focusing light rays into the one or more image sensors (including simple lenses, compound lenses, spherical lenses, and non-spherical lenses). These components may be controlled to capture the first and/or second image frames input to the image processing techniques described herein.

Other aspects, features, and implementations will become apparent to those of ordinary skill in the art, upon reviewing the following description of specific, exemplary aspects in conjunction with the accompanying figures. While features may be discussed relative to certain aspects and figures below, various aspects may include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects may be implemented in various devices, systems, and methods.

The methods described herein may be embedded in a computer-readable medium as computer program code comprising instructions that cause a processor to perform the operations of the method. In some embodiments, the processor may be part of a mobile device including a first network adaptor configured to transmit data, such as images or videos in as a recording or as streaming data, over a first network connection of a plurality of network connections; and a processor coupled to the first network adaptor, and the memory. The processor may execute instructions of the computer-readable medium that cause the transmission of corrected image frames described herein over a wireless communications network such as a 5G NR communication network.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 shows a block diagram of an example device 100 for performing image capture from one or more image sensors.

FIG. 2 shows a block diagram of example image processing based on activity detection according to some embodiments of the disclosure.

FIG. 3 is a flow chart illustrating a method of processing image data based on activity detection according to some embodiments of the disclosure.

FIG. 4 is an illustration showing a rolling shutter correction (RSC) scenario based on activity detection according to some embodiments of the disclosure.

FIG. 5 is a flow chart illustrating a method of processing image data using rolling shutter correction based on activity detection according to some embodiments of the disclosure.

FIG. 6 is an illustration showing an image stabilization (IS) scenario based on activity detection according to some embodiments of the disclosure.

FIG. 7 is a flow chart illustrating a method of processing image data using image stabilization based on activity detection according to some embodiments of the disclosure.

FIG. 8 is a block diagram illustrating image processing with activity detector feedback according to some embodiments of the disclosure.

FIG. 9 is a flow chart illustrating a method of processing image data using image correction based on activity detection with feedback according to some embodiments of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support adapting image processing based on the user activity performed while recording an image. The image processing may include determining an activity indication based on sensor data, such as motion sensors and/or image sensor data, and/or other contextual data, such as what applications are active on the device. The activity indication may be provided to an image processing algorithm, which adapts based on the activity indication. For example, a rolling shutter correction may have a strength factor that is adapted to lower values when the activity indication is for a panning motion. As another example, another image stabilization (IS) algorithm such as an electronic image stabilization (EIS) algorithm may change its behavior based on the activity indication. As some examples, more constant image stabilization may be provided in handheld usage, while walking and running may trigger tracking the user movement faster while panning.

Particular implementations of the subject matter described in this disclosure may be implemented to realize one or more of the following potential advantages or benefits. In some aspects, the present disclosure provides techniques for improving image quality of a photograph and/or a video. The image quality may be improved by improving the image stabilization (IS) operations performed on image data received from an image sensor for generating corrected image frames that become the photograph or video. For example, a rolling shutter correction may inadvertently distort a user's face when performed during certain user activities. An activity detector may detect one of those scenarios and adapt the rolling shutter correction to reduce distortion of a user's face. Other advantages and benefits are described regarding other example operations below.

An example device for capturing image frames using one or more image sensors, such as a smartphone, may include a configuration of two, three, four, or more cameras on a backside (e.g., a side opposite a user display) or a front side (e.g., a same side as a user display) of the device. Devices with multiple image sensors include one or more image signal processors (ISPs), Computer Vision Processors (CVPs) (e.g., AI engines), or other suitable circuitry for processing images captured by the image sensors. The one or more image signal processors may provide processed image frames to a memory and/or a processor (such as an application processor, an image front end (IFE), an image processing engine (IPE), or other suitable processing circuitry) for further processing, such as for encoding, storage, transmission, or other manipulation.

As used herein, image sensor may refer to the image sensor itself and certain other components coupled to the image sensor used to generate an image frame for processing by the image signal processor or other logic circuitry or storage in memory, whether a short-term buffer or longer-term non-volatile memory. For example, an image sensor may include other components of a camera, including a shutter, buffer, or other readout circuitry for accessing individual pixels of an image sensor. The image sensor may further refer to an analog front end (AFE) or other circuitry for converting analog signals to digital representations (e.g., an analog-to-digital converter (ADC)) for the image frame, which may be further processed in digital circuitry coupled to the image sensor.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Aspects of the present disclosure are applicable to any electronic device including or coupled to two or more image sensors capable of capturing image frames (or “frames”).

Further, aspects of the present disclosure may be implemented in devices having or coupled to image sensors of the same or different capabilities and characteristics (such as resolution, shutter speed, sensor type, and so on). Further, aspects of the present disclosure may be implemented in devices for processing image frames, whether or not the device includes or is coupled to the image sensors, such as processing devices that may retrieve stored images for processing, including processing devices present in a cloud computing system.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

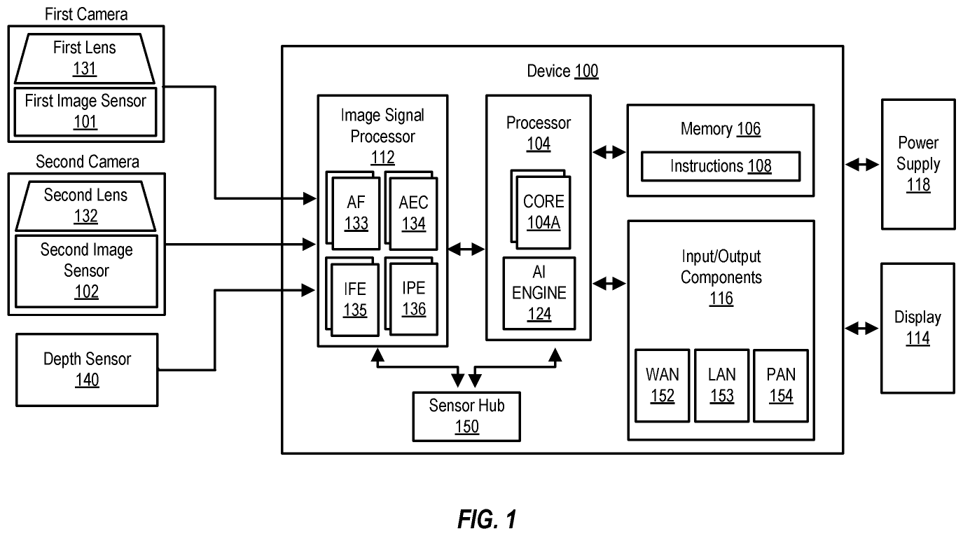

FIG. 1 shows a block diagram of an example device 100 for performing image capture from one or more image sensors. The device 100 may include, or otherwise be coupled to, an image signal processor 112 for processing image frames from one or more image sensors, such as a first image sensor 101, a second image sensor 102, and a depth sensor 140. In some implementations, the device 100 also includes or is coupled to a processor 104 and a memory 106 storing instructions 108. The device 100 may also include or be coupled to a display 114 and input/output (I/O) components 116. I/O components 116 may be used for interacting with a user, such as a touch screen interface and/or physical buttons. I/O components 116 may also include network interfaces for communicating with other devices, including a wide area network (WAN) adaptor 152, a local area network (LAN) adaptor 153, and/or a personal area network (PAN) adaptor 154. An example WAN adaptor is a 4G LTE or a 5G NR wireless network adaptor. An example LAN adaptor 153 is an IEEE 802.11 WiFi wireless network adapter. An example PAN adaptor 154 is a Bluetooth wireless network adaptor. Each of the adaptors 152, 153, and/or 154 may be coupled to an antenna, including multiple antennas configured for primary and diversity reception and/or configured for receiving specific frequency bands. The device 100 may further include or be coupled to a power supply 118 for the device 100, such as a battery or a component to couple the device 100 to an energy source. The device 100 may also include or be coupled to additional features or components that are not shown in FIG. 1. In one example, a wireless interface, which may include transceiver(s) and baseband processor(s), may be coupled to or included in WAN adaptor 152 for a wireless communication device. In a further example, an analog front end (AFE) to convert analog image frame data to digital image frame data may be coupled between the image sensors 101 and 102 and the image signal processor 112.

The device may include or be coupled to a sensor hub 150 for interfacing with sensors to receive data regarding movement of the device 100, data regarding an environment around the device 100, and/or other non-camera sensor data. One example non-camera sensor is a gyroscope, a device configured for measuring rotation, orientation, and/or angular velocity to generate motion data. Another example non-camera sensor is an accelerometer, a device configured for measuring acceleration, which may also be used to determine velocity and distance traveled by appropriately integrating the measured acceleration, and one or more of the acceleration, velocity, and or distance may be included in generated motion data. A further example non-camera sensor is a magnetometer, which measures the direction to magnetic north. In some aspects, a gyroscope in an electronic image stabilization system (EIS) may be coupled to the sensor hub or coupled directly to the image signal processor 112. In another example, a non-camera sensor may be a global positioning system (GPS) receiver. All above sensors may be fused together to increase signal and information quality. The image signal processor 112 may also receive contextual information regarding movement of the device 100 from the processor 104, such as an indication regarding active applications or services executing on the processor 104. For example, an indication of an active run tracking application may indicate the motion of the device 100 is a running activity.

The image signal processor 112 may receive image data, such as used to form image frames. In one embodiment, a local bus connection couples the image signal processor 112 to image sensors 101 and 102 of a first and second camera, respectively. In another embodiment, a wire interface couples the image signal processor 112 to an external image sensor. In a further embodiment, a wireless interface couples the image signal processor 112 to the image sensor 101, 102.

The first camera may include the first image sensor 101 and a corresponding first lens 131. The second camera may include the second image sensor 102 and a corresponding second lens 132. Each of the lenses 131 and 132 may be controlled by an associated autofocus (AF) algorithm 133 executing in the ISP 112, which adjust the lenses 131 and 132 to focus on a particular focal plane at a certain scene depth from the image sensors 101 and 102. The AF algorithm 133 may be assisted by depth sensor 140.

The first image sensor 101 and the second image sensor 102 are configured to capture one or more image frames. Lenses 131 and 132 focus light at the image sensors 101 and 102, respectively, through one or more apertures for receiving light, one or more shutters for blocking light when outside an exposure window, one or more color filter arrays (CFAs) for filtering light outside of specific frequency ranges, one or more analog front ends for converting analog measurements to digital information, and/or other suitable components for imaging. The first lens 131 and second lens 132 may have different fields of view to capture different representations of a scene. For example, the first lens 131 may be an ultra-wide (UW) lens and the second lens 132 may be a wide (W) lens. The multiple image sensors may include a combination of ultra-wide (high field-of-view (FOV)), wide, tele, and ultra-tele (low FOV) sensors. That is, each image sensor may be configured through hardware configuration and/or software settings to obtain different, but overlapping, field of views. In one configuration, the image sensors are configured with different lenses with different magnification ratios that result in different fields of view. The sensors may be configured such that a UW sensor has a larger FOV than a W sensor, which has a larger FOV than a T sensor, which has a larger FOV than a UT sensor. For example, a sensor configured for wide FOV may capture fields of view in the range of 64-84 degrees, a sensor configured for ultra-side FOV may capture fields of view in the range of 100-140 degrees, a sensor configured for tele FOV may capture fields of view in the range of 10-30 degrees, and a sensor configured for ultra-tele FOV may capture fields of view in the range of 1-8 degrees.

The image signal processor 112 processes image frames captured by the image sensors 101 and 102. While FIG. 1 illustrates the device 100 as including two image sensors 101 and 102 coupled to the image signal processor 112, any number (e.g., one, two, three, four, five, six, etc.) of image sensors may be coupled to the image signal processor 112. In some aspects, depth sensors such as depth sensor 140 may be coupled to the image signal processor 112 and output from the depth sensors processed in a similar manner to that of image sensors 101 and 102. In addition, any number of additional image sensors or image signal processors may exist for the device 100.

In some embodiments, the image signal processor 112 may execute instructions from a memory, such as instructions 108 from the memory 106, instructions stored in a separate memory coupled to or included in the image signal processor 112, or instructions provided by the processor 104. In addition, or in the alternative, the image signal processor 112 may include specific hardware (such as one or more integrated circuits (ICs)) configured to perform one or more operations described in the present disclosure. For example, the image signal processor 112 may include one or more image front ends (IFEs) 135, one or more image post-processing engines 136 (IPEs), and or one or more auto exposure compensation (AEC) 134 engines. The AF 133, AEC 134, IFE 135, IPE 136 may each include application-specific circuitry, may be embodied as software code executed by the ISP 112, and/or may be a combination of hardware and software.

In some implementations, the memory 106 may include a non-transient or non-transitory computer readable medium storing computer-executable instructions 108 to perform all or a portion of one or more operations described in this disclosure. In some implementations, the instructions 108 include a camera application (or other suitable application) to be executed by the device 100 for generating images or videos. The instructions 108 may also include other applications or programs executed by the device 100, such as an operating system and specific applications other than for image or video generation. Execution of the camera application, such as by the processor 104, may cause the device 100 to generate images using the image sensors 101 and 102 and the image signal processor 112. The memory 106 may also be accessed by the image signal processor 112 to store processed frames or may be accessed by the processor 104 to obtain the processed frames. In some embodiments, the device 100 does not include the memory 106. For example, the device 100 may be a circuit including the image signal processor 112, and the memory may be outside the device 100. The device 100 may be coupled to an external memory and configured to access the memory for writing output frames for display or long-term storage. In some embodiments, the device 100 is a system on chip (SoC) that incorporates the image signal processor 112, the processor 104, the sensor hub 150, the memory 106, and input/output components 116 into a single package.

In some embodiments, at least one of the image signal processor 112 or the processor 104 executes instructions to perform various operations described herein, including noise reduction operations. For example, execution of the instructions can instruct the image signal processor 112 to begin or end capturing an image frame or a sequence of image frames, in which the capture includes noise reduction as described in embodiments herein. In some embodiments, the processor 104 may include one or more general-purpose processor cores 104A capable of executing scripts or instructions of one or more software programs, such as instructions 108 stored within the memory 106. For example, the processor 104 may include one or more application processors configured to execute the camera application (or other suitable application for generating images or video) stored in the memory 106.

In executing the camera application, the processor 104 may be configured to instruct the image signal processor 112 to perform one or more operations with reference to the image sensors 101 or 102. For example, the camera application may receive a command to begin a video preview display upon which a video comprising a sequence of image frames is captured and processed from one or more image sensors 101 or 102. Image correction, such as with cascaded IPEs, may be applied to one or more image frames in the sequence. Execution of instructions 108 outside of the camera application by the processor 104 may also cause the device 100 to perform any number of functions or operations. In some embodiments, the processor 104 may include ICs or other hardware (e.g., an artificial intelligence (AI) engine 124 having one or more circuits configured for executing machine learning (ML) algorithms) in addition to the ability to execute software to cause the device 100 to perform a number of functions or operations, such as the operations described herein. In some other embodiments, the device 100 does not include the processor 104, such as when all of the described functionality is configured in the image signal processor 112.

In some embodiments, the display 114 may include one or more suitable displays or screens allowing for user interaction and/or to present items to the user, such as a preview of the image frames being captured by the image sensors 101 and 102. In some embodiments, the display 114 is a touch-sensitive display. The I/O components 116 may be or include any suitable mechanism, interface, or device to receive input (such as commands) from the user and to provide output to the user through the display 114. For example, the I/O components 116 may include (but are not limited to) a graphical user interface (GUI), a keyboard, a mouse, a microphone, speakers, a squeezable bezel, one or more buttons (such as a power button), a slider, a switch, and so on.

While shown to be coupled to each other via the processor 104, components (such as the processor 104, the memory 106, the image signal processor 112, the display 114, and the I/O components 116) may be coupled to each another in other various arrangements, such as via one or more local buses, which are not shown for simplicity. While the image signal processor 112 is illustrated as separate from the processor 104, the image signal processor 112 may be a core of a processor 104 that is an application processor unit (APU), included in a system on chip (SoC), or otherwise included with the processor 104. While the device 100 is referred to in the examples herein for performing aspects of the present disclosure, some device components may not be shown in FIG. 1 to prevent obscuring aspects of the present disclosure. Additionally, other components, numbers of components, or combinations of components may be included in a suitable device for performing aspects of the present disclosure. As such, the present disclosure is not limited to a specific device or configuration of components, including the device 100.

Image stabilization may be performed by the image capture device 100 to compensate for motion of the image capture device 100 during recording of image data. Certain stabilization algorithms may not be optimal for conditions encountered by the image capture device resulting in the stabilization algorithms unintentionally adding distortion. Shortcomings mentioned here are only representative and are included to highlight problems that the inventors have identified with respect to existing devices and sought to improve upon. Aspects of devices described below may address some or all of the shortcomings as well as others known in the art. Aspects of the improved devices described herein may present other benefits than, and be used in other applications than, those described above.

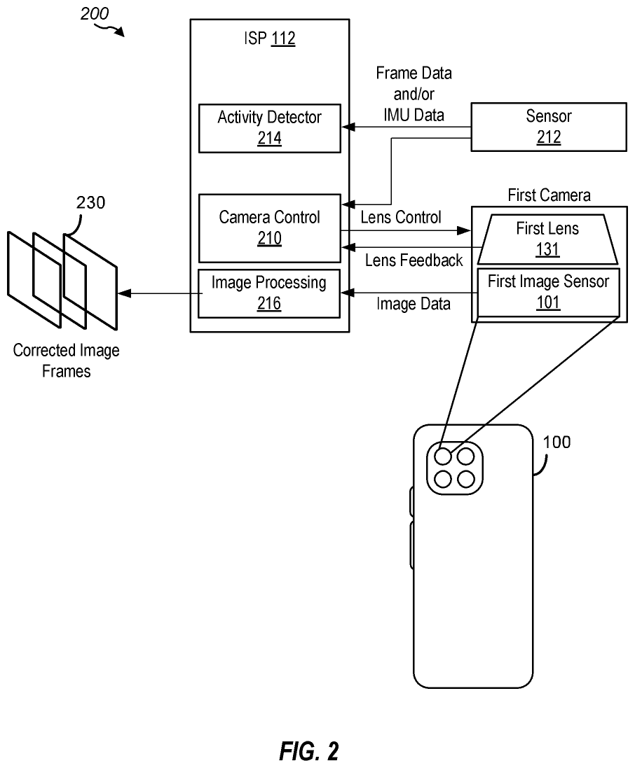

Information regarding a user activity during recording of image data may be used to adapt an image stabilization algorithm based on the user activity. FIG. 2 shows a block diagram of example image processing based on activity detection according to some embodiments of the disclosure. A system 200 illustrates processing of data from a first camera of image capture device 100. An ISP 112 may receive image data from image sensor 101 for image processing 216. A sensor 212 may provide inertial measurement unit (IMU) data and/or other types of data to activity detector 214. For example, sensor 212 may be an accelerometer, gyroscope, and/or magnetometer. In some embodiments, the sensor 212 may be incorporated into the first camera, such as when sensor 212 is a gyroscope that is part of an image stabilization (IS) system that also includes the lens 131 and image sensor 101. In another example, sensor 212 may be a component outside of the camera and otherwise included in image capture device 100. In a further example, sensor 212 may be an external component in communication, such as through a wireless connection, with image capture device 100. In some embodiments, the sensor 212 may be a motion detector configured to detect motion by analyzing image data received from the image sensor 101 or another image sensor of the image capture device 100. For example, the sensor 212 may include a motion vector determination unit that receives a series of image frames as image data, determines one or more motion vectors indicating a scene movement from a first image frame to a second image frame in the series of image frames, and provides the one or more motion vectors to the activity detector 214. The motion vectors are one example of data that can be extracted from the image data regarding device motion and/or user activity. Another example of information that may be extracted from the image data and used to determine a type of activity includes facial landmarks detected in an image data of the image frame, such as using a computer vision (CV) algorithm.

The activity detector 214 may use data provided from sensor 212 to determine a current activity type of the user of the image capture device 100. For example, the activity detector 214 may determine whether a user is engaged with the phone or has the phone in their pocket. As another example, the activity detector 214 may determine whether a user is sitting, standing, walking, or running. As a further example, the activity detector 214 may determine whether the user is panning the camera across an area. The activity detector 214 may provide the activity type to camera control 210 and/or image processing 216 to change operation of the image capture device 100 based on the activity type. Different activity types of the plurality of activity types may have different configurations for image stabilization (including EIS, OIS, and/or DIS) and/or different configurations for other aspects of the image capture device.

In some embodiments, the activity detector 214 may use other context information available from the image capture device for determining an activity. For example, when the image capture device 100 is a mobile computing device, the activity detector 214 may use a time of day, day of year, time of last user activity on a touchscreen, executing applications, location, active network connections, etc. to assist in detecting a current activity. The activity detector 214 may detect based on the time of day being night and the location being indoor at a building and enhance data from sensor 212 to determine likely activity and predict a next, or near-future, activity. As another example, the activity detector 214 may detect based on a foreground application being a run tracking software that data from sensor 212 represents a person either running or walking. Although the activity detector 214 is shown executing in ISP 112, the activity detector 214 may execute on different hardware, such as one of the processor cores 104A and/or the AI engine 124.

Camera control 210 may control image capture by the first camera. For example, camera control 210 may include an autofocus (AF) algorithm that controls lens 131 to identify an optimal focal distance for capturing image data by the image sensor 101. As another example, camera control 210 may include an image stabilization algorithm, such as an optical image stabilization (OIS) algorithm, that controls movement of the lens 131 to compensate for shaking and other movement of the image capture device 100 during recording of the image data. Camera control 210 may use a motion scene/activity indication received from the activity detector 214 to adjust a digital or optical image stabilization algorithm. For example, the image stabilization algorithm may include making one or more decisions or adjusting filters for determining appropriate control of the lens 131. The factors (e.g., filter weights) in the stabilization algorithm may be adjusted based on the scene indicator, such that the lens control for image stabilization is different when the user of the camera is running than when the user is standing still.

Image processing 216 receives image data from the image sensor 101 and processes the image data to generate one or more corrected image frames 230. The corrected image frames 230 may be output as part of a preview image to a user and/or recorded to a file for later recall and playback by a user. Image processing 216 may use the activity indication from activity detector 214 when processing the image data. Determination of one or more corrected image frames 230 may be based on the image data received from sensor 101 and/or based on an activity indication from activity detector 214. For example, image processing 216 may include a rolling shutter correction (RSC) algorithm and/or a lens correction algorithm, each of which may be separately controlled based on the activity indication.

Although arrows are shown between certain blocks within the system 200, data may flow between blocks in additional ways to those shown in FIG. 2. For example, data from sensor 212 may flow directly to camera control 210 in addition to, or in alternative to, the activity detector 214. As another example, data may flow from activity detector 214 to image processing 216 in addition to, or in alternative to, flow to the camera control 210.

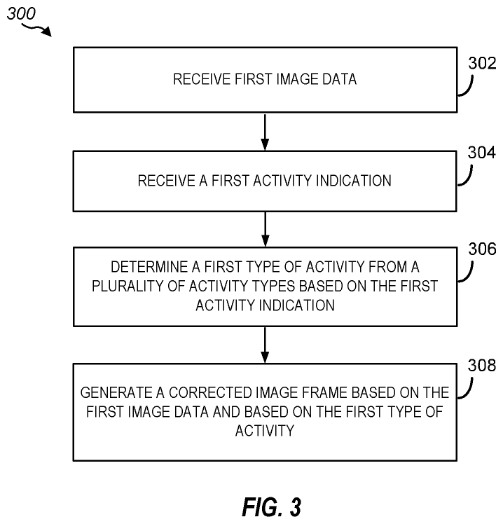

A method for processing image data, such as in the data flow of FIG. 2, is shown in FIG. 3. FIG. 3 is a flow chart illustrating a method of processing image data based on activity detection according to some embodiments of the disclosure. A method 300 includes, at block 302, receiving first image data. The first image data may be image data received from one or more image sensors. The image data may represent a scene within the field of view of the one or more image sensors. In some embodiments, the image data processed by image processing 216 is fused image data combining data from two or more image sensors.

At block 304, the method 300 includes receiving a first activity indication. Example data for the activity indication includes accelerometer data, gyroscope data, image sensor data, compass data, magnetometer data, and altimeter data.

At block 306, a type of activity is determined from a plurality of activity types based on the first activity indication received at block 306. The type of activity may specify a particular user activity (e.g., sitting, standing, walking, running, exercising indoors, walking outdoors) or may specify a classification of user activity (e.g., office activity, home activity, exercise activity, indoor activity, outdoor activity, etc.). The type of activity may be determined by an activity detector that uses data available to the image capture device.

At block 308, the method 300 includes generating a corrected image frame based on the first image data and based on the first type of activity. The corrected image frame may be determined by determining a first image frame from the first image data. The first image data may be further processed, and one or more algorithms performed during the processing may be based on the type of activity. Adapting the image processing, such as when adapting an image stabilization behavior, in view of the type of activity may improve image quality and reduce the introduction of artifacts into image frames determined from the image data. Adapting the image stabilization behavior may include applying different behaviors in a decision-making process for image stabilization, adapting an adaptive filter, and/or revising filter weights. For example, when the type of activity is panning, a rolling shutter correction (RSC) may be adjusted to avoid geometric distortion, but other types of activities, such as running or handheld, may have different applications of the rolling shutter correction (RSC).

In some embodiments, the modification of IS behavior may include changing a weighting factor k when the following equation is implemented for image stabilization. In traditional image stabilization techniques, the previous motion estimation F(n−1) and the current frame-level motion vector V(n) is integrated by the following equation:

$$F ( n ) = [ k \times F ( n - 1 ) ] + V ( n ) ,$$

wherein the “weighting factor” k is a constant that is adjusted based on the type of activity. A previous global-motion vector F(n−1) is used in the calculation of the current cumulative frame-level vector F(n). The constant k can be considered to be the relative weight of the history, or past, in integrating the current frame-level motion vector V(n) from the previous motion estimation F(n−1). The equation can be implemented, for example, by a single-pole, low-pass filter (LPF), in part because certain motion, such as hand shaking, of video capturing is a low-frequency event (ordinarily less than about fifteen hertz). The constant k controls the damping rate of the low-pass filter and is used to ensure that the “cut out” (i.e., the cropped and zoomed) image determined for the image frame from the first image data is slowly moving to the center of the padded image.

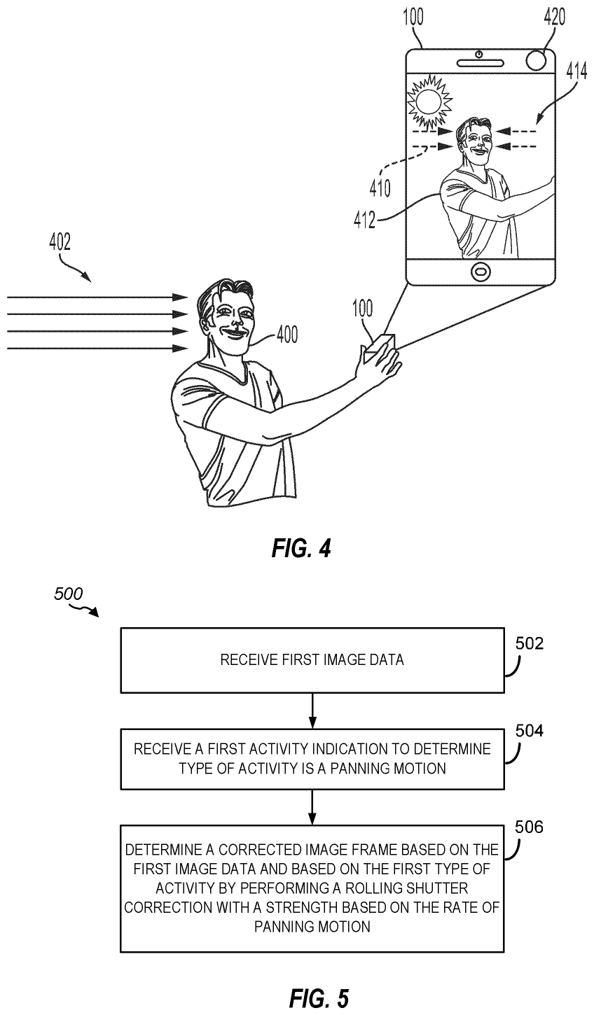

One example image processing adjusted based on activity detection is rolling shutter correction (RSC), such as described with reference to FIG. 4 and FIG. 5. FIG. 4 is an illustration showing a rolling shutter correction (RSC) scenario based on activity detection according to some embodiments of the disclosure. FIG. 5 is a flow chart illustrating a method of processing image data using rolling shutter correction based on activity detection according to some embodiments of the disclosure. A user 400 may use image capture device 100 to record a selfie using camera 420. The camera 420 may record a representation 412 of the user 400 in the scene as part of a preview display 410. The user 400 may pan the image capture device 100 in motion 402. Conventionally, a rolling shutter correction (RSC) applied to the image data having representation 412 of the user 400 would create an output image frame in preview image 410 in which the user 400's face is compressed 414 along the direction of panning motion 402. The result is that the preview image 410 is an inaccurate representation and/or is considered a low-quality image quality. Detection of user activity indicating the user is panning the camera may be used to adjust the rolling shutter correction (RSC), such as to reduce a strength of the correction and reduce or eliminate distortion 414.

An adjustment to image processing may be performed according to method 500, including receiving first image data at block 502 and, at block 504, receiving a first activity indicating a panning motion. At block 506, a corrected image frame may be determined based on the first image data and based on the first activity type indicating a panning motion. The adjustment of the image processing at block 506 may include performing a rolling shutter correction (RSC) with a strength based on the rate of the panning motion. In some embodiments, the strength of the RSC may be based on additional rules, such as camera metadata indicating the first image data is received from a front-facing camera (or a rear-facing camera or other situation involving the camera and the object, such as the face, moving as a rigid body) and/or an object detection unit indicating a face exists in the first image data. The strength of the RSC may be decreased in proportion to the speed of the panning motion, such that a high-speed panning motion results in a decrease of the RSC strength to reduce distortion to the face in the corrected image frame of block 506. In some embodiments, the adjustment of the rolling shutter correction based on the activity type may be preconditioned on conditions including the detection of the use of a front-facing camera and/or on detection of a face in the scene representation captured in the first image data.

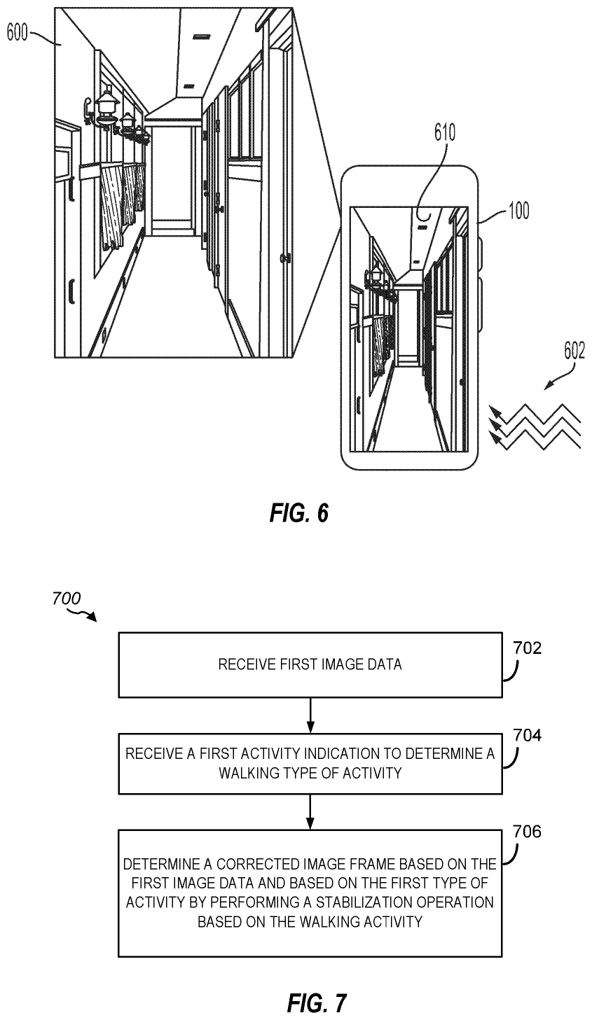

Another example of image processing adjusted based on user activity is an adjustment of image stabilization based on detected activity, such as described with reference to FIG. 6 and FIG. 7. FIG. 6 is an illustration showing an image stabilization (IS) scenario based on activity detection according to some embodiments of the disclosure. FIG. 7 is a flow chart illustrating a method of processing image data using image stabilization based on activity detection according to some embodiments of the disclosure. A user may be walking down a hallway 600 while taking video with a rear-facing camera of image capture device 100. The image capture device 100 may display a preview image 610 including a representation of hallway 600. Shaking of the user's hands while taking the video may cause shaking 602 of the preview image 610. The shaking 602 may be undesirable and reduce the perceived image quality of the video recording.

Image stabilization (IS) techniques can be applied to image data recorded by the rear-facing camera to reduce the appearance of shaking 602 in the preview image 610. Example image stabilization (IS) techniques may include optical image stabilization (OIS), electronic image stabilization (EIS), and digital image stabilization (DIS). These IS techniques may include parameters for smoothing the representation of a scene from one image frame to another image frame, and the smoothing parameters for the smoothing may be adjusted based on the user's activity. For example, a first smoothing filter strength may be applied when the user is walking, and a stronger second smoothing filter strength may be applied when the user is running. The smoothing filtering may be configured with parameters based on an activity type received from activity detector. In some embodiments, an IS technique may include one or more filters for determining an appropriate image correction based on sensor input. The filter weights may be set to different values based on the user's activity.

In some embodiments, the IS technique may support OIS centering behavior and the user's activity may be used to adjust fixing of the OIS to a center location. For example, the activity detector may determine whether an image capture device is in a tripod mode. Such an activity detection may be based on analyzing a motion of the image capture device and/or determining an RFID tag of a tripod communicates with image capture device. As another example, the activity detector may determine whether an image capture device is being used outdoors. The image capture device may be configured when in a tripod mode to fix OIS to a center location. The image capture device may be configured when in an outdoor scenario with a short exposure time to fix OIS to a center location. Conditions for configuring the parameters to not fix OIS to a center location may include a high zoom setting (e.g., >5× zoom), an outdoor scene, and/or while moving (e.g., the user is walking or running).

A method 700 for adjusting image stabilization (IS) as part of correcting image frames includes receiving first image data at block 702 and receiving a first activity type indicating a walking activity at block 704. At block 706, a corrected image frame is determined based on the first image data received at block 702 and based on the first activity type received at block 704. The corrected image frame may be determined by performing a stabilization operation based on the type that the user is in a walking activity. The stabilization operation may have parameters adjusted in response to the received type of the walking activity. For example, a smoothing filter may be configured with parameters, such as a strength and/or time windows, to a first set of values corresponding to a walking activity.

Activity detection changes may be predicted based on a current activity type. For example, a user that recently started walking may soon begin running. An algorithm in the activity detector detects user activity and classifies the user activity for a current frame and predicts an activity class for future frames. The activity detector may provide an activity type reflecting the predicted activity to image processing algorithms. The processing algorithms may behave adaptively according to the activity class, which may produce smoother videos for some scenarios and/or faster transitions for some scenarios.

In some embodiments of this prediction for determining the activity type, the activity detector 214 may receive an activity indication and determine a type of activity from a plurality of activities based on a current state of the user activity. In such an operation, a next, or second, type of activity is based on a current, or first, type of activity. Feedback in the activity detector 214 based on a previous activity type may improve the accuracy of the activity detector 214 in determining a change in activity. For example, when a current activity type is standing, the activity detector 214 may reduce the likelihood that a next activity type is running because it is unusual for a user to proceed directly from standing to running. Rather, when a current activity type is standing, the activity detector 214 may increase the likelihood that a next activity type is walking because a user is likely to start moving from a standing position slowly at first and then faster.

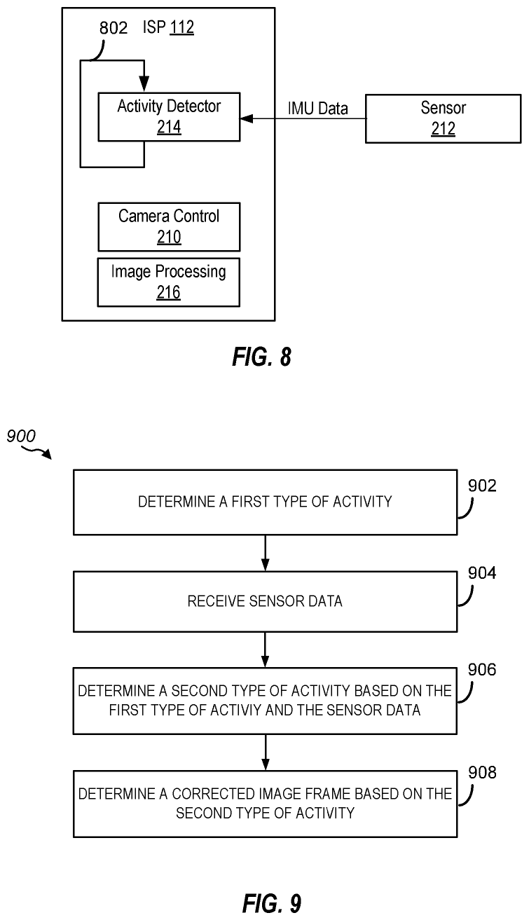

An example operation of image processing using an activity detector with feedback is shown in FIG. 8 and FIG. 9. FIG. 8 is a block diagram illustrating image processing with activity detector feedback according to some embodiments of the disclosure. An activity detector 214 may have a feedback loop 802 such that future activity types are determined based on an existing activity type. FIG. 9 is a flow chart illustrating a method of processing image data using image correction based on activity detection with feedback according to some embodiments of the disclosure. A method 900, performed by the activity detector 214, includes receiving a first activity type at block 902 and receiving sensor data at block 904. At block 906, a second activity type is determined based on the first activity type of block 902 and the sensor data of block 904. At block 908, a corrected image frame may be generated based on the second activity type.

In one or more aspects, techniques for supporting image processing may include additional aspects, such as any single aspect or any combination of aspects described below or in connection with one or more other processes or devices described elsewhere herein. In a first aspect, supporting image processing may include an apparatus, such as an image capture device, configured to perform operations including receiving first image data; receiving a first activity indication; determining a first type of activity from a plurality of activity types based on the first activity indication; and/or generating an image frame based on the first image data and based on the first type of activity by applying image stabilization to the first image data based on the first type of activity. Additionally, the apparatus may perform or operate according to one or more aspects as described below. In some implementations, the apparatus includes a wireless device, such as a UE or BS. In some implementations, the apparatus may include at least one processor, and a memory coupled to the processor. The processor may be configured to perform operations described herein with respect to the apparatus. In some other implementations, the apparatus may include a non-transitory computer-readable medium having program code recorded thereon and the program code may be executable by a computer for causing the computer to perform operations described herein with reference to the apparatus. In some implementations, the apparatus may include one or more means configured to perform operations described herein. In some implementations, a method of wireless communication may include one or more operations described herein with reference to the apparatus.

In a second aspect, in combination with the first aspect, applying the image stabilization comprises applying a distortion correction to the first image data based on the first type of activity.

In a fourth aspect, in combination with one or more of the first aspect through the third aspect, applying the image stabilization comprises at least one of: applying a rolling shutter correction to the first image data with a correction strength based on the first type of activity; applying lens distortion correct to the first image data based on the first type of activity; and applying a z-lens position compensation to the first image data based on the first type of activity.

In a fifth aspect, in combination with one or more of the first aspect through the fourth aspect, determining the first type of activity comprises determining the first image data is obtained by an image capture device during a panning motion of the image capture device.

In a sixth aspect, in combination with one or more of the first aspect through the fifth aspect, the first activity indication comprises at least one of data from a gyroscope, an accelerometer, or a magnetometer, or data extracted from the first image data.

In a seventh aspect, in combination with one or more of the first aspect through the sixth aspect, applying the image stabilization comprises adapting an adaptive filter based on the first type of activity.

In an eighth aspect, in combination with one or more of the first aspect through the seventh aspect, the operations performed by the at least one processor further include determining a second type of activity based on the first type of activity; receiving second image data; and generating a second image frame based on the second image data and based on the second type of activity by applying the image stabilization to the second image data based on the second type of activity.

In a ninth aspect, in combination with one or more of the first aspect through the eighth aspect, determining the first image data is received from a front-facing camera; determining a face exists in the first image data; determining the first type of activity comprises determining a pan motion; and applying the image stabilization comprises applying a rolling shutter correction to the first image data with a correction strength based on the first type of activity.

In a tenth aspect, in combination with one or more of the first aspect through the ninth aspect, applying the image stabilization comprises performing an optical image stabilization (OIS) centering command based on the first type of activity.

In an eleventh aspect, in combination with one or more of the first aspect through the tenth aspect, the apparatus may further include an image sensor coupled to the processor, wherein the processor is configured to receive the first image data from the image sensor.

In a twelfth aspect, in combination with one or more of the first aspect through the eleventh aspect, the apparatus may further include a motion sensor coupled to the processor, wherein determining the first activity indication is further based on inertial measurement unit (IMU) data from the motion sensor.

In a thirteenth aspect, in combination with one or more of the first aspect through the twelfth aspect, the apparatus may further include a sensor hub, wherein the sensor hub is configured to receive inertial measurement unit (IMU) data for use in determining a first type of activity.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-9 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes. 1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method, comprising:
receiving first image data;
receiving a first activity indication;
determining a first type of activity from a plurality of activity types based on the first activity indication; and
generating an image frame based on the first image data and based on the first type of activity by applying image stabilization to the first image data based on the first type of activity.

2. The method of claim 1, wherein applying the image stabilization comprises applying a distortion correction to the first image data based on the first type of activity.

3. The method of claim 2, wherein applying the image stabilization comprises at least one of:
applying a rolling shutter correction to the first image data with a correction strength based on the first type of activity;
applying lens distortion correct to the first image data based on the first type of activity; and
applying a z-lens position compensation to the first image data based on the first type of activity.

4. The method of claim 2, wherein determining the first type of activity comprises determining the first image data is obtained by an image capture device during a panning motion of the image capture device.

5. The method of claim 1, wherein the first activity indication comprises at least one of data from a gyroscope, an accelerometer, or a magnetometer, or data extracted from the first image data.

6. The method of claim 1, wherein applying the image stabilization comprises adapting an adaptive filter based on the first type of activity.

7. The method of claim 1, further comprising:
determining a second type of activity based on the first type of activity;
receiving second image data; and
generating a second image frame based on the second image data and based on the second type of activity by applying the image stabilization to the second image data based on the second type of activity.

8. The method of claim 1, wherein:
determining a face exists in the first image data;
determining the first type of activity comprises determining a pan motion; and
applying the image stabilization comprises applying a rolling shutter correction to the first image data with a correction strength based on the first type of activity.

9. The method of claim 1, wherein applying the image stabilization comprises performing an optical image stabilization (OIS) centering command based on the first type of activity.

10. An apparatus, comprising:
a memory storing processor-readable code;
at least one processor coupled to the memory, the at least one processor configured to execute the processor-readable code to cause the at least one processor to perform steps comprising:
receiving first image data;
receiving a first activity indication;
determining a first type of activity from a plurality of activity types based on the first activity indication; and
generating an image frame based on the first image data and based on the first type of activity by applying image stabilization to the first image data based on the first type of activity.

11. The apparatus of claim 10, wherein applying the image stabilization comprises applying a distortion correction to the first image data based on the first type of activity.

12. The apparatus of claim 11, wherein applying the image stabilization comprises at least one of:
applying a rolling shutter correction to the first image data with a correction strength based on the first type of activity;
applying lens distortion correct to the first image data based on the first type of activity; and
applying a z-lens position compensation to the first image data based on the first type of activity.

13. The apparatus of claim 11, wherein determining the first type of activity comprises determining the first image data is obtained by an image capture device during a panning motion of the image capture device.

14. The apparatus of claim 10, wherein the first activity indication comprises data from a gyroscope, an accelerometer, or a magnetometer, or data extracted from the first image data.

15. The apparatus of claim 10, wherein applying the image stabilization comprises adapting an adaptive filter based on the first type of activity.

16. The apparatus of claim 10, wherein the at least one processor is configured to execute the processor-readable code to cause the at least one processor to perform further steps comprising:
determining a second type of activity based on the first type of activity;
receiving second image data; and
determining a second image frame based on the second image data and based on the second type of activity.

17. The apparatus of claim 10, wherein:
determining a face exists in the first image data;
determining the first type of activity comprises determining a pan motion; and
applying the image stabilization comprises applying a rolling shutter correction to the first image data with a correction strength based on the first type of activity.

18. The apparatus of claim 10, wherein applying the image stabilization comprises performing an optical image stabilization (OIS) centering command based on the first type of activity.

19. The apparatus of claim 10, further comprising:
an image sensor coupled to the processor, wherein the processor is configured to receive the first image data from the image sensor.

20. The apparatus of claim 19, further comprising:
a motion sensor coupled to the processor,
wherein determining the first activity indication is further based on inertial measurement unit (IMU) data from the motion sensor.

21. A non-transitory computer-readable medium storing instructions that, when executed by a processor, cause the processor to perform operations comprising:
receiving first image data;
receiving a first activity indication;
determining a first type of activity from a plurality of activity types based on the first activity indication; and
generating an image frame based on the first image data and based on the first type of activity by applying image stabilization to the first image data based on the first type of activity.

22. The non-transitory, computer-readable medium of claim 21, wherein applying the image stabilization comprises applying a distortion correction to the first image data based on the first type of activity.

23. The non-transitory, computer-readable medium of claim 21, wherein:
applying the image stabilization comprises applying a rolling shutter correction to the first image data with a correction strength based on the first type of activity; and
determining the first type of activity comprises determining a panning motion of the image capture device.

24. The non-transitory, computer-readable medium of claim 21, wherein on the first activity indication comprises at least one of data from a gyroscope, an accelerometer, or a magnetometer, or data extracted from the first image data.

25. The non-transitory, computer-readable medium of claim 21, wherein receiving the first activity indication comprises receiving a change in facial boundaries in the first image data.

26. The non-transitory, computer-readable medium of claim 21, wherein applying the image stabilization comprises adapting an adaptive filter based on the first type of activity.

27. An image capture device, comprising:
an image sensor;
a memory storing processor-readable code;
a sensor hub;
at least one processor coupled to the memory, to the image sensor, and to the sensor hub, the at least one processor configured to execute the processor-readable code to cause the at least one processor to perform steps comprising:
receiving first image data from the image sensor;
receiving inertial measurement unit (IMU) data from the sensor hub;
determining a first type of activity from a plurality of activity types based on the IMU data; and
generating an image frame based on the first image data and based on the first type of activity by applying image stabilization to the first image data based on the first type of activity.

28. The image capture device of claim 27, wherein applying the image stabilization comprises applying a rolling shutter correction to the first image data with a correction strength based on the first type of activity, and wherein determining the first type of activity comprises determining a panning motion.

29. The image capture device of claim 27, further comprising an accelerometer coupled to the sensor hub, wherein determining the first type of activity is based on accelerometer data.

30. The image capture device of claim 27, wherein the at least one processor is further configured to execute the processor-readable code to cause the at least one processor to perform steps comprising:
determining a second type of activity based on the first type of activity;
receiving second image data; and
determining a second image frame based on the second image data and based on the second type of activity by applying the image stabilization to the second image data based on the second type of activity.
